(19) United States
(12) Patent Application Publication
(10) Pub. No.: US 2018/0308149 A1
(43) Pub. Date: Oct. 25, 2018

(54) SYSTEMS AND METHODS TO CURATE, SUGGEST AND MAINTAIN A WARDROBE

(71) Applicant: FASHIONALITY INC., Olympia, WA (US)

(72) Inventors: Bei-Jing Guo, Seattle, WA (US); Long Cheng, Bellevue, WA (US); Pavani Haridasyam, Redmond, WA (US); Yuan Yuan Zhou, Bellevue, WA (US); Zhike Kong, Sammamish, WA (US)

(21) Appl. No.: 15/956,592

(22) Filed: Apr. 18, 2018

Related U.S. Application Data
(60) Provisional application No. 62/489,693, filed on Apr. 25, 2017.

(51) Int. Cl. G06Q 30/06; G06N 3/04; G06F 17/30

(52) U.S. Cl. CPC G06Q 30/0631; G06F 17/30268; G06Q 30/0643; G06N 3/0445

(57) ABSTRACT

A system for building outfits is disclosed. The system may include a tagging system configured to receive a user's clothing items and tag the clothing items according to their attributes. The system may also include an outfit generation engine coupled in electronic communication with the tagging system and configured to receive the tagged clothing items from the tagging system and outfit templates and, using the outfit templates and the tagged clothing items, form a set of recommended outfits. The system may also include a user system coupled in electronic communication with the outfit generation engine and configured to receive at least one of the recommended outfits from the outfit generation engine and receive qualitative feedback about the recommended outfit from the user and send the feedback to the outfit generation engine.

### CROSS-REFERENCE

This application claims the benefit of U.S. Provisional Application No. 62/489,693, filed Apr. 25, 2017, which application is incorporated herein by reference.

### BACKGROUND

Presently, solutions and systems for curating and maintaining wardrobes have excessive costs associated with personal consultants offering wardrobe solutions. A need exists for removing wardrobe personal consultants and offers flexibility and is based on machine learning for an user.

### SUMMARY

A system for building outfits is disclosed. The system may include a tagging system configured to receive a user's clothing items and tag the clothing items according to their attributes. The system may also include an outfit generation engine coupled in electronic communication with the tagging system and configured to receive the tagged clothing items from the tagging system and outfit templates and, using the outfit templates and the tagged clothing items, form a set of recommended outfits. The system may also include a user system coupled in electronic communication with the outfit generation engine and configured to receive at least one of the recommended outfits from the outfit generation engine and receive qualitative feedback about the recommended outfit from the user and send the feedback to the outfit generation engine.

A method for building outfits is also disclosed. The method may comprise tagging a user's clothing items according to their attributes. The method may also include forming a set of recommended outfits based on the tagged clothing items and a set of outfit templates. In some embodiments, the method may include receiving feedback from the user about at least one recommended outfit of the set of recommended outfits and may also include forming a second set of recommended outfits based on the feedback, tagged clothing items, and the set of outfit templates

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts a process and data flow for an outfit system, in accordance with one or more embodiments herein;

FIG. 2 depicts a method for providing outfit suggestions, in accordance with one or more embodiments herein;

FIG. 3 depicts a system for providing outfit suggestions, in accordance with one or more embodiments herein;

FIG. 4 depicts an outfit recommendation, in accordance with one or more embodiments herein;

FIG. 5 depicts an outfit recommendation database, in accordance with one or more embodiments herein;

FIG. 6 depicts a calendar of outfits, in accordance with one or more embodiments herein;

FIG. 7 depicts collections of outfits, in accordance with one or more embodiments herein;

FIG. 8 depicts a clothing item and associated outfits, in accordance with one or more embodiments herein;

FIG. 9 depicts a closet or wardrobe database, in accordance with one or more embodiments herein;

FIG. 10 depicts the rejection of an outfit recommendation, in accordance with one or more embodiments herein;

FIG. 11 depicts the liking an outfit recommendation, in accordance with one or more embodiments herein;

FIG. 12 depicts the selecting an outfit recommendation for wearing, in accordance with one or more embodiments herein.

### DETAILED DESCRIPTION

A better understanding of the features and advantages of the present disclosure will be obtained by reference to the following detailed description that sets forth illustrative embodiments, in which the principles of embodiments of the present disclosure are utilized, and the accompanying drawings.

Although the detailed description contains many specifics, these should not be construed as limiting the scope of the disclosure, but merely as illustrating different examples and aspects of the present disclosure. It should be appreciated that the scope of the disclosure includes other embodiments not discussed in detail herein. Various other modifications, changes and variations which will be apparent to those skilled in the art may be made in the arrangement, operation and details of the methods, systems, and apparatus of the present disclosure provided herein without departing from the spirit and scope of the disclosure, as described herein.

As disclosed herein, a system and method for helping users extract value from their wardrobe by showing them new outfit combinations they can make with their existing clothing is described. In one embodiment, a template, such as a fashion photograph featuring a full body shot of a single model is used to build an outfit suggestion from a person's wardrobe of clothes. The outfit suggestion includes the template along with pictures of a user's clothing items from their wardrobe. The selected clothing items may have been matched to items in the template to create the same or similar fashion look as that presented in the template.

In another aspect, the systems and methods described herein include a mechanism for showing a user how to get more out of their closet. The systems and methods rely on a fashion recommendation engine, where user preferences are signaled by feedback, such as a combination of approved looks and clothing items owned by the user. The recommendation engine uses these signals to suggest looks that the user likes and that the user is able to approximate with their existing wardrobe. The recommendation engine may also take into account environmental variables, such as weather, and user's calendar events when preparing recommended outfits.

As the system has learned the type of looks the user prefers, items may be suggested to the user for purchase in order to increase the number of outfits a user can create based on the templates. The recommendation engine may present additions to the wardrobe that approximate matches to items in templates that the user may be missing in order to identify clothing items for addition to the user's wardrobe.

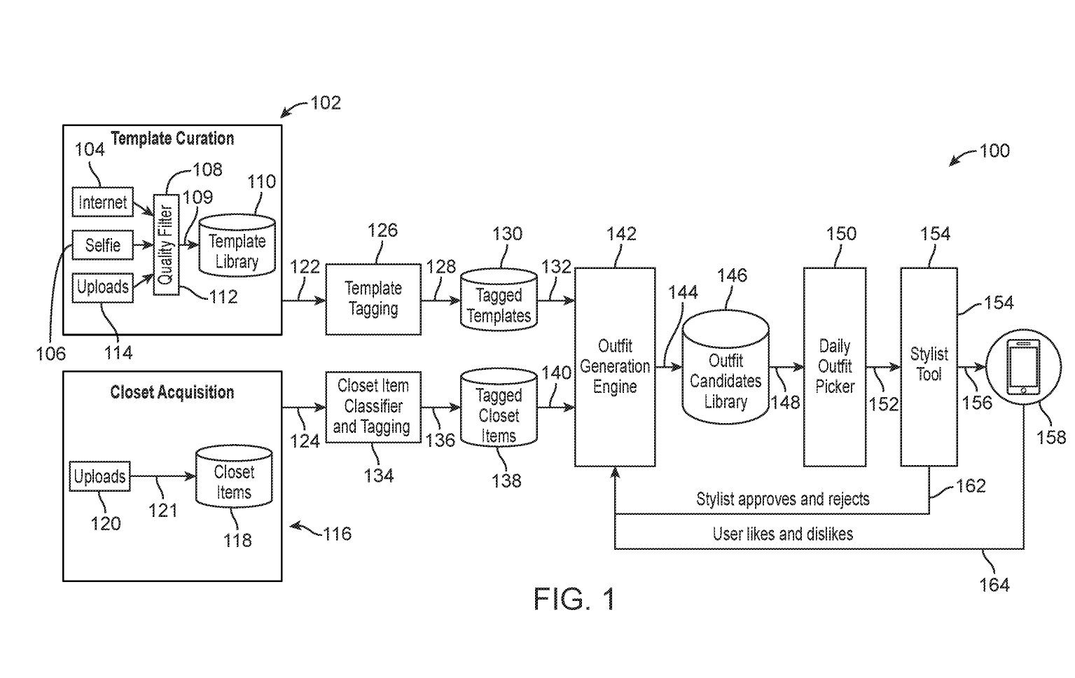

FIG. 1 depicts a process and data flow 100 for an outfit selection system. The fashion curation block 102 includes the steps of collecting images and other media as initial outfit templates and filtering those templates.

Fashion images for the templates may be sourced from the internet 104. For example, images may be sourced from content providers such as fashion blogs or fashion websites or by web crawlers, which periodically retrieve templates from a list of sources. Fashion images may also be sourced from user photos 106, such as selfies of a user wearing their own clothes. The fashion images can be uploaded into the system. For example they may be uploaded to a template library 110 prior to filtering. Fashion images may also be internally sourced, for example, from photograph uploads 114 of models in stylist designed outfits.

The fashion images may be automatically checked for quality control. In the quality control check, images may be rejected due to poor lighting, for example, where the average brightness of the photo is below a threshold, or wherein identified parts of the photograph, such as the person's face, or clothing has a brightness below a threshold. In some embodiments, facial detection is used in the quality control process to determine whether a human face is shown in the outfit template photos, if not, the image may be rejected. Similarly if more than one human face is detected, the image may be rejected. In some embodiments, a body of a person, is detected and any images that do not show a person's full body may be rejected. The position of the model's body may be determined and any images that do not show the frontal view of the model are rejected. The template images that pass the automatic quality control checks are sent to the template library 110 over communication path 109.

After an image has been added to the template library 110, the image may be sent to or retrieved by the template tagging system 126. The template tagging system 126, which may also be referred to as a template tagging tool, assigns the value of attributes of the outfit shown in the template. The attributes may be specified by a data schema. Examples of attributes and values are: Clothing Category (Top, Bottom, Setwear, Outerwear, Shoes, Bags, Scarfs); Top Type (Blouse, T-shirt, Button Shirt, Sweater, Tank Top, Cardigan, Camisole, Vest); Blouse Sleeve Length (Sleeveless, Cap Sleeve, Short Sleeve, Long Sleeve). The template tagging tool marks and assigns a value to one or more or all the attributes that describe the outfit using the data schema.

The template tagging system 126 uses an object detection convolutional neural network model to detect and classify one or more or all the clothing items in an image. By doing so, the template tagging system separates the clothing item or items of interest from the background in the image. This detection and classification of one or more or all of the possible clothing items in an image helps the detection and classification images where the clothing item is of complicated design. For example, in the situation when multiple types or patterns co-exist in the image. For example, a T-shirt may have both a “Polka dots” and a “stripes” design, because the classifier isolates the clothing items, in this case the T-shirt, from the image background, the classifier will be able to tell which pattern dominates the T-shirt by comparing the areas of “Polka dots” vs. “stripes”.

A traditional classifier tags their training data with all dimensions in or attributes combined in a single classifier. For example, in a traditional classifier may be built to recognize clothing type (e.g. “T-shirt”), color (e.g. “yellow”), and pattern (i.e. “stripes”). This traditional classifier would tag their training data as a yellow AND striped AND T-shirt or a red AND animal-print AND blouse, etc. This is like performing multiplication on dimensions and substantially reduces the quality of resulting tags and the ability of the traditional classifier to properly tag a photo.

The disclosed template tagging system addresses this multi-dimensional tagging problem by separating each tagging dimension, e.g., a tagging system for each dimension or attribute. In some embodiments, the tagging system classifies and tags in parallel. The disclosed template tagging system 126 uses a classifier trained to tag training data using addition. The template tagging system 126 uses a plurality of classifiers, each to classify a different aspect of an object. For example, template tagging system 126 may include a classifier to recognize color, a classifier to recognize pattern, and a classifier to recognize type, etc. The benefit of this approach is that during training, each classifier is focused on their respective training data tagging, and thereby produces higher quality training, more accurate classification, and more accurate tagging.

Table 1 shows an example of a template schema.

TABLE 1

| | | |
|---|---|---|
| templates | id | Unique Template Identifier |
| | image | Information to retrieve the image of the |
| | | template |
| | tags | Tags generated by the Template Tagging |
| | | System |
| | items | The list of items that make up the template |
| | status | New, rejected, tagged (active), retired |
| | createdTime | The date and time the template was created |
| | createdBy | Whether this template was created by a stylist, |
| | | user, or from the internet. |
| | metadata | Additional information regarding the template |

The list of items that make up the template may be a list of item IDs that correspond to items in a database. For example, the items may be defined by a schema as shown in Table 2.

TABLE 2

| | | |
|---|---|---|
| items | id | Unique item identifier |
| | category | The category of the item, e.g., Top, Bottom, |
| | | Outerwear, Accessory, etc |
| | type | The type of the item, e.g., Blouse, Button Up, |
| | | T-shirt, etc. |
| | features | Item tags: color, style, etc. |
| | metadata | Additional information regarding the template |

Furthermore, traditional tagging tags the entire image, rather than the multiple individual items within an image. Before classification of the clothing items in an image, the template tagging system 126 detects each clothing item and identifies its location in the image. For example, in some embodiments, a bounding box is placed around the each time. A bounding box may be a polygon the vertices that are indicated by coordinates within the images, such as pixel coordinates. Each bounding box may be assigned a tag or string corresponding to each target clothes item in the image. The template tagging system 126 may then learn to detect clothes items by iterating through the whole labelled training set and back-propagating loss value through the CNN network. Compared to the whole image classification, the classifier focuses on the “interesting” spots in the image, e.g., the locations that have been identified by bounding boxes as having a clothing item therein. Such a system and method wherein the detection and classification process occur separately and one after the other provides better tagging accuracy.

After the clothing items within a template have been identified and tagged, the template is sent to or retrieved by the template tagging storage and database 130 over connection 128.

The closet acquisition block 116 includes the steps of collecting images of each item of clothing in a user's wardrobe. The images of clothing items may be retrieved from or sent by a user or other person who takes photos of each item of clothing and send them over communication path 121 so that them may be stored in the closet item library 118. In some embodiments, clothing items may be acquired by scraping a user's emails for purchase receipts, which may include links to the images of the purchased item. These images may then be retrieved and stored in the closet items library 118.

After an image has been added to the closet items library 118, the image of the item may be sent to or retrieved by the closet item classifier and tagging system 134. The closet item classifier and tagging system 134, which may also be referred to as a clothing tagging tool, assigns the value of attributes of the clothing item shown in each closet item photo. A closet item photo may be of a single piece or article of clothing, however, in some embodiments, a single image my include multiple items of clothing and the closet item classifier and tagging system 134 separates each article in the image for separate classification, tagging, and/or storage. The tagged attributes of clothing may be specified by a data schema. Examples of attributes and values are: clothing category, such as top, bottom, setwear, outerwear, shoes, bags, scarfs, etc; top type, for example, blouse, t-shirt, button shirt, sweater, tank top, cardigan, camisole, vest, etc.; blouse sleeve length, for example, sleeveless, cap sleeve, short sleeve, long sleeve, etc, and other attributes and values. The clothing tagging tool marks and assigns a value to one or more or all the attributes that describe the article or articles in the image using the data schema.

Like the template tagging system 126, the closet item classifier and tagging system 134 uses an object detection convolutional neural network model to detect and classify one or more or all the clothing items in an image. By doing so, the template tagging system separates the clothing item or items of interest from the background in the image.

The closet item classifier and tagging system 134 uses a classifier trained to tag data using addition. The closet item classifier and tagging system 134 uses a plurality of classifiers, each to classify a different aspect of an object. For example, closet item classifier and tagging system 134 may include a classifier to recognize color, a classifier to recognize pattern, and a classifier to recognize type, etc. The benefit of this approach is that during training, each classifier is focused on their respective training data tagging, and thereby produces higher quality training, more accurate classification, and more accurate tagging. In some embodiments, the tagging system classifies and tags in parallel.

Table 3 shows an example of a closet item schema.

TABLE 3

| | | |
|---|---|---|
| closetItems | id | Unique closet item identifier |
| | userId | User ID of the user to which the item |
| | | belongs |
| | image | Information to retrieve the image of the |
| | | template |
| | item | The list of items that make up the closet item |
| | createdTime | The date and time the template was created |
| | status | New, rejected, tagged (active), retired |
| | metadata | Additional information regarding the |
| | | template |

The item that makes up the closetltem may be an item ID that corresponds to an item in a database. For example, the item may be defined by a schema as shown in Table 2, above.

As with the template tagging system 126, the closet item classifier and tagging system 134 may learn to detect clothes items by iterating through a labelled training set and back-propagating loss value through the CNN network. Compared to the whole image classification, the classifier focuses on the “interesting” spots in the image, e.g., the locations that have been identified as having clothing items, providing better tagging accuracy.

After the clothing items within a closet item image have been identified and tagged, the closet item is sent to or retrieved by the tagged closet item system and database 138 over connection 136.

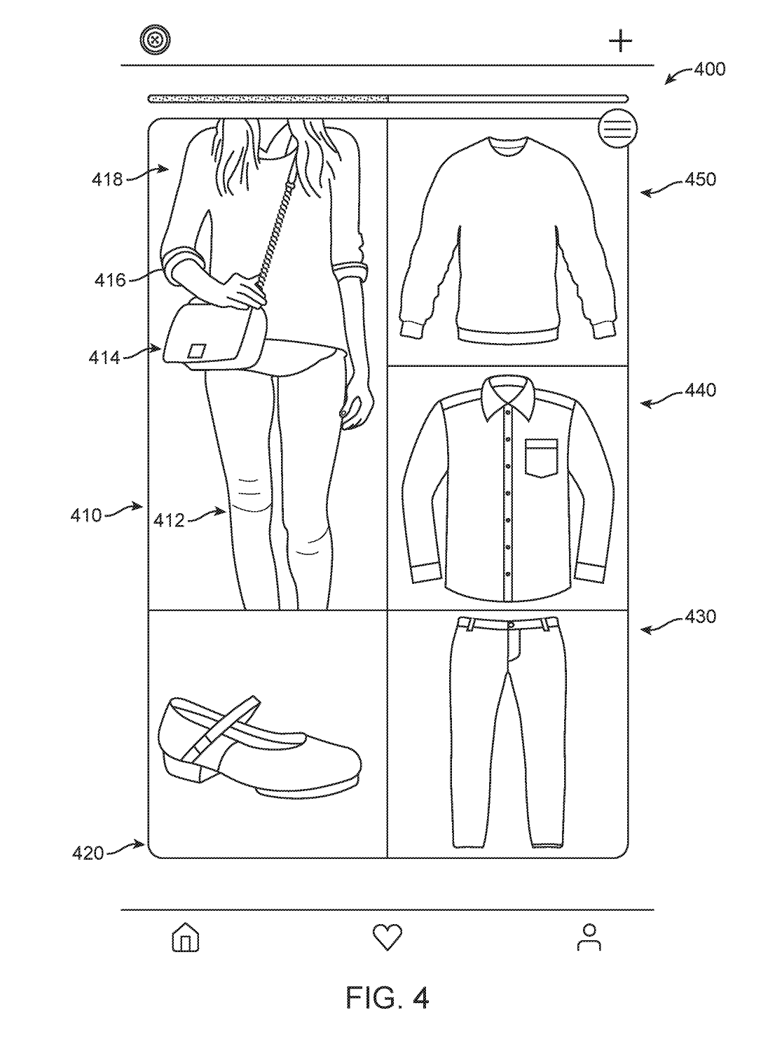

After the tagged templates and tagged closet items are created, the outfit generation engine 142 uses the tagged templates and tagged closet items to generate outfit recommendation candidates. An outfit recommendation candidate may include a template image and corresponding closet items that are selected as matching the items in the template, see FIG. 4.

The outfit generation engine 142 matches the tagged templates with tagged closet items to create an outfit recommendation candidate. The outfit generation engine 142 uses two probabilistic ranking models to match templates with user's closet items. The first probability ranking model is based on conditional probability, for example, the relevance probability of a template given a user's closet information and the template-user-item matches, which may be determined by the stylists. The first probably ranking model may be expressed as P(template|user, template-user-item matches). The second probability ranking model is based on the conditional probability of a user's closet item given a (relevant) template and the information of template-user-item matches. The second probability ranking model may be expressed as P(item|user, template, template-user-item matches), this is the relevance probability. The first probability model uses a user's closet items as query to query relevant templates. For each returned template, such as a top template, or ranking of templates, the second probability model uses this template or templates as a query or queries to pull the relevant items from this user's closet. Both models may use human judgement for training so that changes in template-user-item matches will propagate into the respective ranking results. The algorithms may be semi-supervised machine learning algorithms. In some embodiments, the outfit generation engine uses two probabilistic ranking models to match templates with user's closet items. The first probability ranking model is based on conditional probability, for example, the relevance probability of a template given a user's personal style preferences, as indicated, for example, by the user's past likes and dislikes. In this way, the first model filters out the templates that are not a style-match with the user. The second model then matches theses style-match templates from the output of the first model with the clothing items in the user's closet. In this way the recommended outfits including clothing that items that match with the user's own clothes and are also aligned with user's personal style.

The ranking algorithm may be boot strapped using a rule-based filtering engine to generate an initial set of outfit candidate as training data. For each user closet, all possible combinations of closet items may be first constructed for a template using a rule based filtering engine. The rule sets for the rule based filtering engine may be defined by stylists and may include rules such as, for example, that each type of closet item (top/bottom/shoes, etc) has to match at least one of the template's item types. These initial set of outfit candidates are used to train the ranking system and its associated probability ranking models.

The outfit generation engine may then send a subset of the generated outfits to the outfit candidate library 146 via the communication path 144. The subset of generated outfits may be based on a raking of generated outfits, wherein the top 20, 30, 50, 100, or 200 outfits are sent to or retrieved by the outfit candidate library. In some embodiments, all complete outfit candidates are sent to the outfit candidate library 146. In some embodiments, outfit candidates may be sent to the outfit candidate library based on other aspects of the outfits, for example, rules may be used such that a certain minimum number of outfits match a certain criteria, such as at least 15 outfits must include an item type of jacket and sweater so that a user may have outfits for rainy and cold weather.

Table 4 depicts a schema for an outfit recommendation.

TABLE 4

| | | |
|---|---|---|
| Outfit | id | Unique outfit item identifier |
| Recommendation | userId | User ID of the user for which the |
| | | outfit was generated |
| | forDate | Date the outfit was delivered |
| | userStatus | Whether the outfit is unviewed, |
| | | viewed, liked, disliked |
| | templateId | The unique template identifier of the |
| | | template |
| | closetItemsIds | The unique closet item identifiers of |
| | | the closet items in the outfit |
| | status | Whether the outfit was generated, |
| | | accepted, rejected |
| | createdTime | The date and time the outfit was |
| | | generated |
| | metadata | Additional information regarding the |
| | | template |

The daily outfit picker 150 may select one or more outfit recommendations from all the available outfit candidates for presentation to the user and retrieve the selection over communication path 148. The goal of the selection is to pick the outfit that is most appropriate and is most diverse from this user's previous recommendations. For example, the selection engine considers the user's previous likes, weather conditions, day of the week, and user's last-worn-date of closet items when selecting an outfit. The daily outfit picker 150 may connect to other resources, such as a user's calendar to determine who they are meeting with during the day. The daily outfit picker 150 can then look at past outfits that were worn when the user met with the same people they are meeting with on the present day and select outfits that use different items than the last time or times they met.

The ranking results and the daily outfit or outfits may be shown to stylists in stylist tools 154. A stylist examines the ranking results and may approve appropriate combinations as officially accepted recommendation candidates. The ranking feedback from stylists may be used to retrain the ranking algorithm on a periodic basis, such as once every day, to improve outfit candidate generation results.

Stylists can also overwrite the generated recommendations using the stylist tool 154. For example, the stylist can view every user's profile information, such as their past recommendation history, their likes and dislikes, their closet details, clothing items the user has expressed interest in, such as though a wish list. The stylist can then review the outfit recommendation form the daily outfit picker 150 and either replace the recommendation entirely by creating a new one or selecting another outfit candidate, or modifying the recommendation by substituting individual closet items. The stylists' changes may be recorded and used as feedback for the outfit generation engine models. Such feedback is provided via the communication path 162. The stylist may also use the tool to view user's wish list items to create and push buy recommendations to the user.

The user device, which may be a computing device, such as a mobile phone, receives the daily outfit recommendation and displays the outfit to the user. Feedback, such as a user's likes and dislikes, may be received by the user device and proved via communication path 164 to the recommendation engine 142. The user may also view and manage their closet, including adding items via item acquisition or remove items by deleting them from the tagged closet items library 138. The user drive may also enable the user to view and manage their saved favorite recommendations, social features, and view and manage a wish list, and receive suggestions on items to buy.

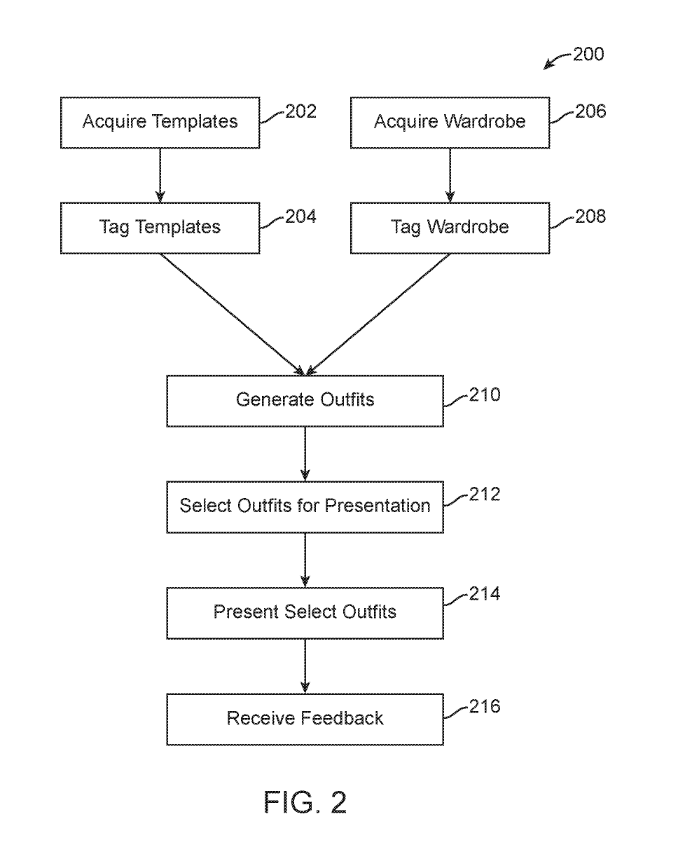

FIG. 2 depicts a method 200 for providing outfit suggestions, in accordance with one or more embodiments herein. At block 202 templates are acquired. The templates may be acquired by the fashion curation block 102 of FIG. 1. Acquiring templates may include collecting images and other media as initial outfit templates and filtering those templates.

The templates may be acquired from the internet 104, including via content providers such as fashion blogs or fashion websites or by web crawlers, which periodically retrieve templates from a list of sources curated by our stylists. In some embodiments, users may provide templates, which can be uploaded into the system to an initial outfit template library prior to filtering. In some embodiments, internally sourced photograph uploads 114 of models in stylist outfits may be used as templates. These template images may be automatically checked for quality control at block 202. In the quality control checks, images may be rejected due to poor lighting. In some embodiments, facial detection is used to determine whether a human face is shown in the initial outfit template photos, if not, the image may be rejected. Similarly if more than one human face is detected, the image may be rejected. In some embodiments, images that do not show a person's full body may be rejected. The template images that pass the automatic quality control checks are sent to the template library 110.

At block 204 the templates are tagged. In some embodiments, the template tagging system 126 of FIG. 1, assigns the value of attributes of the outfit shown in the template. Examples of attributes and values are: Clothing Category (Top, Bottom, Setwear, Outerwear, Shoes, Bags, Scarfs); Top Type (Blouse, T-shirt, Button Shirt, Sweater, Tank Top, Cardigan, Camisole, Vest); Blouse Sleeve Length (Sleeveless, Cap Sleeve, Short Sleeve, Long Sleeve). The template tagging tool marks and assigns a value to one or more or all the attributes that describe the outfit using the data schema. A convolutional neural network may be used to tag the templates, as described above.

At block 206 a wardrobe is acquired. Acquiring images of each piece of clothing of a user's wardrobe may include collecting images of each item of clothing in a user's wardrobe. The images of clothing items may be retrieved from or sent by a user or other person who takes photos of each item of clothing and then the images may be stored in the closet item library 118 of FIG. 1. In some embodiments, clothing items may be acquired via scraping a user's emails for purchase receipts, which may include links to the images of the purchased item. These images may then be retrieved and stored in the closet items library 118.

At block 208 the wardrobe items are tagged. In some embodiments, each piece of clothing in a user's wardrobe is tagged using the closet tagging and classifier system 134 of FIG. 1. During tagging, each attribute of the clothing item is assigned a value. The attributes may be specified by a data schema. Examples of attributes and values are: Clothing Category (Top, Bottom, Setwear, Outerwear, Shoes, Bags, Scarfs); Top Type (Blouse, Tshirt, Button Shirt, Sweater, Tank Top, Cardigan, Camisole, Vest); Blouse Sleeve Length (Sleeveless, Cap Sleeve, Short Sleeve, Long Sleeve). The template tagging tool marks and assigns a value to one or more or all the attributes that describe each clothing item using the data schema. A convolutional neural network may be used to tag the clothing items, as described above.

At block 210 outfits are generated. The outfits may be generated based on a combination of tagged templates and tagged closet items. For example an outfit recommendation candidate may include a template image and corresponding closet items that are selected as matching the items in the template.

The outfit generation engine 142 of FIG. 1 may be used to generate the outfits. During outfit generation, the tagged templates are matched with tagged closet items to create an outfit recommendation candidate. Two probabilistic ranking models may be used to match templates with user's closet items. The first probability ranking model may be based on conditional probability, for example, the relevance probability of a template given a user's closet information and the template-user-item matches decided by the stylists, as described above, and the second probability ranking model may be based on the conditional probability of a user's closet item given a (relevant) template and the information of template-user-item matches, as described above. The first probability model may use a user's closet items as a query to query relevant templates. For each returned template, such as a top template, or ranking of templates, the second probability model uses this template or templates as a query or queries to pull the relevant items from this user's closet.

At block 212 outfits are selected for presentation to a user. One or more outfit recommendations may be selected from all the available outfit candidates for presentation to the user. The selection may be based on which outfit is most appropriate and is most diverse from the user's previous recommendations. For example, the selection engine considers the user's previous likes, weather conditions, day of the week, and user's last-worn-date of closet items when selecting an outfit. The selection may take into account other factors, such as a user's calendar to determine who they are meeting with during the day. For example, past outfits or items that were worn when the user met with the same people they are meeting with on the present day may be taken into account such that different items and outfits, other than those worn the last time the user met, may be selected.

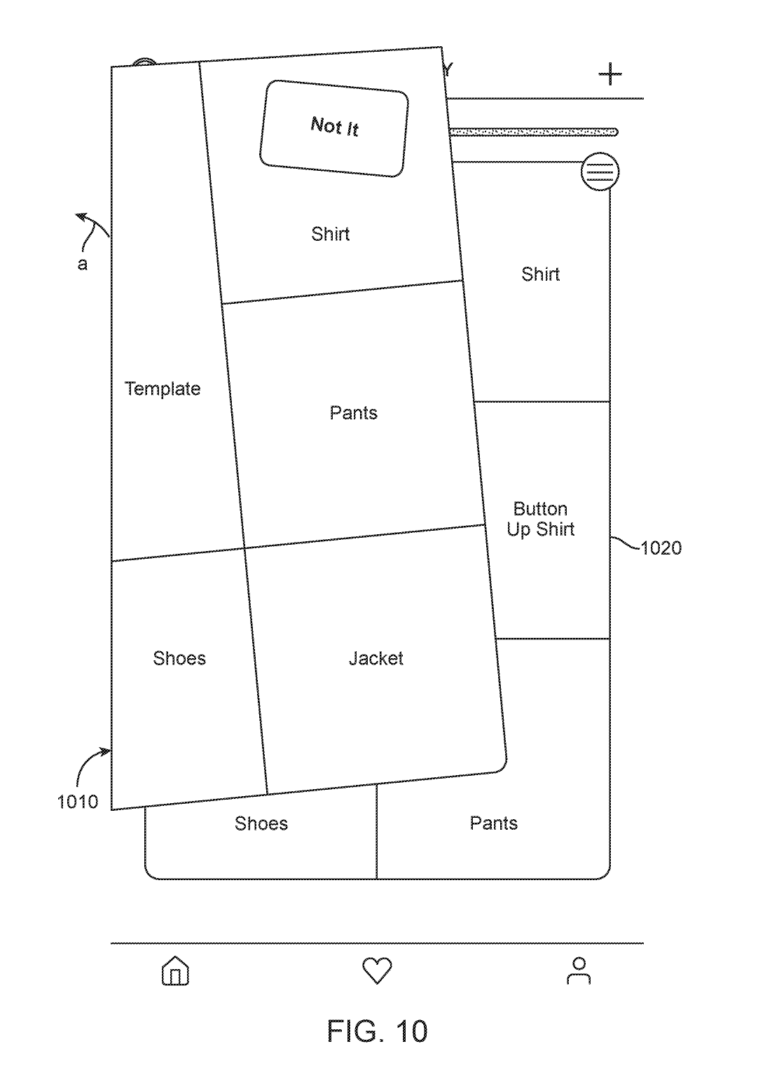

At block 214 the outfits are presented. In some embodiments, the outfits are present to the user and the user likes, accepts, or rejects the outfit, for example, as depicted in FIGS. 10-12. At block 216 the user's selection is then used as feedback to the system and used, for example, by outfit generation engine 142, in generating additional outfit recommendations or to revise outfit recommendations.

In some embodiments, the outfits are presented to a stylist before being presented to the user. In this case, the stylist may reject an outfit and the rejected outfit is not presented to the user. Such feedback by the stylist may also be received by the system at block 216. Stylists can also modify a recommended outfit by adding, removing, or substituting one or more of the suggested closet items for a different closet item. Stylists can also replace the computer-suggested outfit by an entirely different outfit. The changes made by the stylist may be sent back to the recommendation engine as feedback for use in generating.

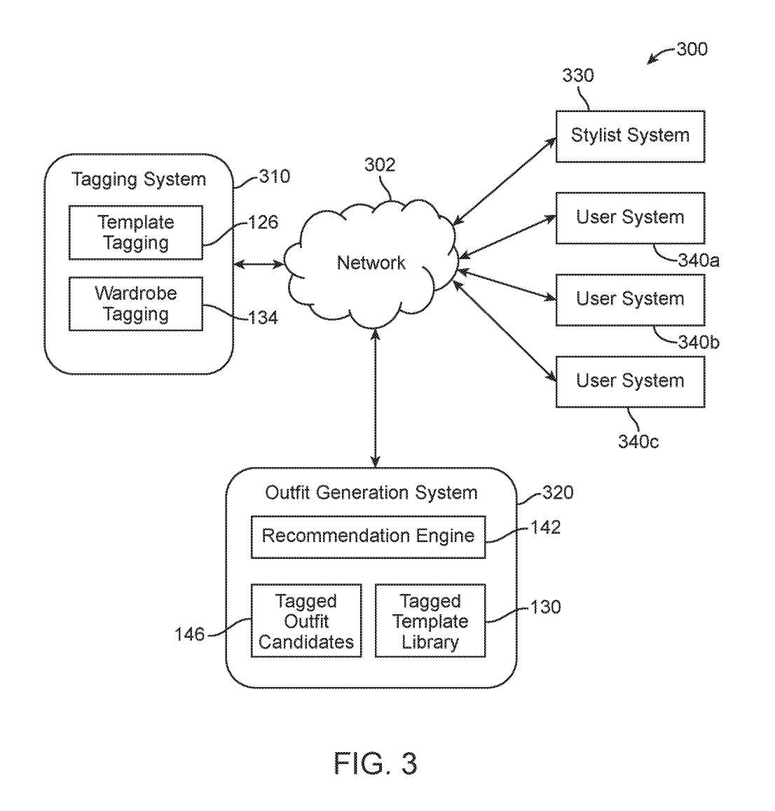

FIG. 3 depicts a system 300 for providing outfit suggestions, in accordance with one or more embodiments herein. The system 300 may include a tagging system 310, an outfit generation system 320, one or more stylist systems 330, and one or more user systems 340 connected to each other in electronic communication via a network 302, which may be the internet.

The tagging system 310 and the outfit generation system 320 may be disparate systems, as depicted in FIG. 3, or they may be a single system on one or more servers. The tagging system 310 includes a template tagging module, which may be software executed on a computing system that carries out the template tagging and classification functions discussed above. The tagging system 301 may also include a wardrobe or closet tagging module, which may be software executed on a computing system that carries out the wardrobe tagging and classification functions discussed above.

The outfit generation system 320 may include the recommendation engine 142, the tagged outfit library 146, and the tagged template library 130, all of which are as described above with respect to FIG. 1. The recommendation engine 142 may be a module, which may be software executed on a computer system that carries out the recommendation engine functions, described above.

The system 300 may also include one or more stylist systems 330. The stylist systems may be disparate from the other systems described herein, or may be combined with these systems. For example, the stylist system may be executed on the same computing device or devices as the outfit generation system and the tagging system, but present a user interface on a separate device, such as a stylist's computer or user's mobile device. The stylist system carries out the functions of the stylist tool, as described above with respect to FIG. 1.

The system 300 may also include one or more user systems 340a, 340b, 340c. The user systems 340 may be disparate from the other systems described herein, or may be combined with these systems. For example, the user systems 340 may be executed on the same computing device or devices as the outfit generation system and the tagging system, but present a user interface on a separate device, such as a user's computer or mobile device. The user system carries out the functions of the user device 158, as described above with respect to FIG. 1.

FIG. 4 depicts an outfit recommendation 400. The outfit recommendation 400 may be a recommendation from the recommendation engine 132 and stored in the outfit candidate library 146, as described above with respect to FIG. 1. The outfit recommendation includes a template 410, and wardrobe items 420, 430, 440, and 450. The template shows an outfitted model. The model's outfit includes pants 412, a sweater 418, a shirt 440, a bag 412, and shoes. In the outfit recommendation 400, each of the wardrobe items 420, 430, 440, and 450 matches the corresponding items in the model's outfit. For example, the shoes 420 match the model's shoes, the pants 430 match the model's pants 412, the shirt 440 matches the model's shirt 416, and the sweater 450 matches the model's sweater 418.

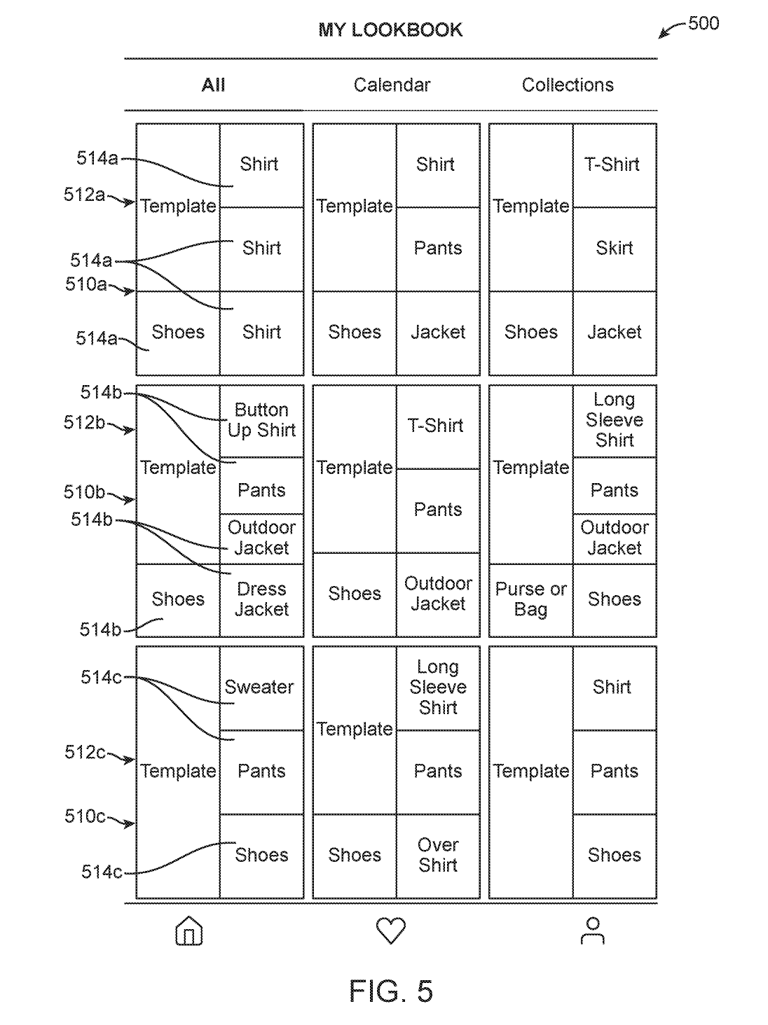

FIG. 5 depicts an outfit library 500 and the outfits 510 therein. Each outfit 510 in the outfit library 500 may be displayed for a user or stylist. The outfit library 500 may be a selection of outfits that the user previously liked and expressed an interest in. In some embodiments, Each of the outfits 510a, 510b, 510c include depictions, such as images of the corresponding wardrobe items 514a, 514b, 514c from the user's wardrobe. In some embodiments, the outfits 510 are outfit recommendations and using this interface, a user may provide feedback on the outfits, such as by liking them, rejecting them, disliking them, selecting favorites, and other types of feedback. The feedback may be used by the recommendation engine.

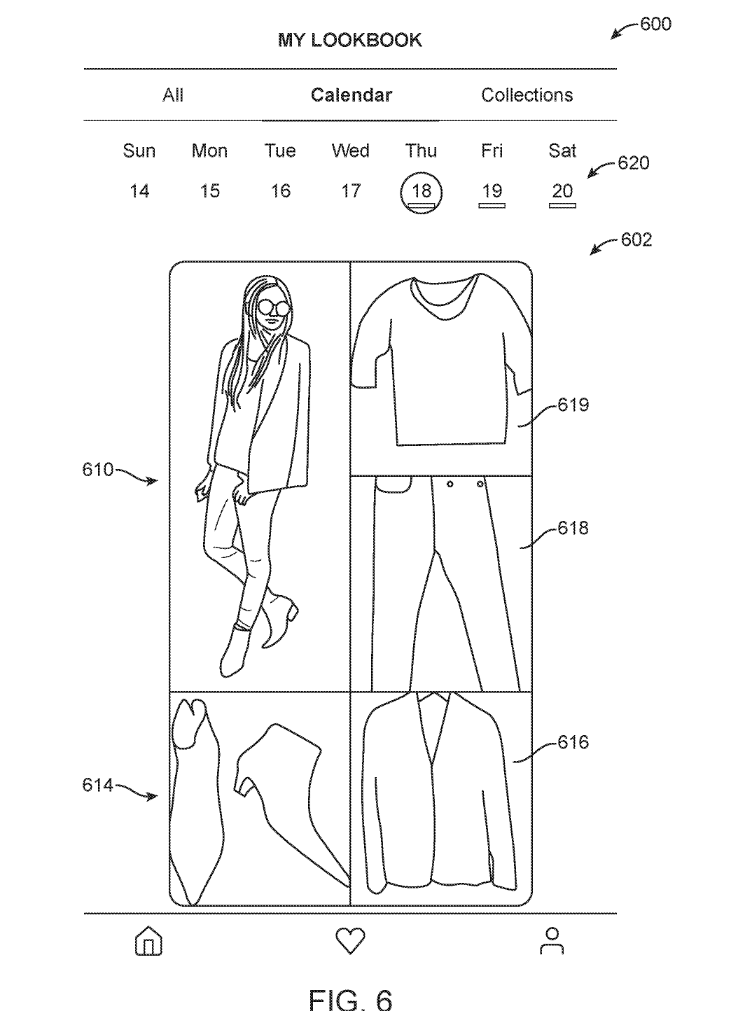

FIG. 6 depicts a calendar 600 of outfits 602 therein. A user may select a calendar day 620 in order to view the recommended outfit 602 for that particular day. Selecting past days shows the outfits worn on those days and selecting the current or future days shows the recommended outfit for that day. Each outfit 602 includes a template 610 and the user's wardrobe items 614, 616, 618, 619 that are matched by the outfit generation engine to the template 610. In some embodiments, a user may view a recommended outfit, for example, an outfit recommended for the current day and attached that outfit to a future date.

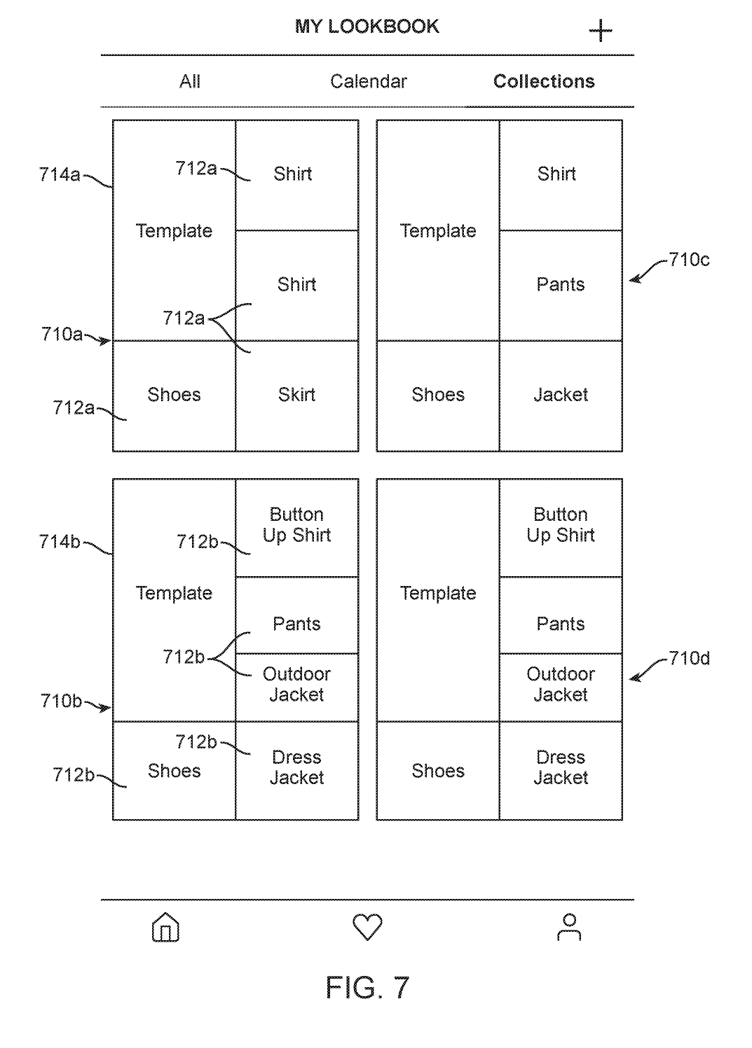

FIG. 7 depicts collections of outfits. Each collection 710 may correspond to a grouping of outfits. For example, collections may be made based on the outfits to be worn on a trip as in collection 710a, while collection 710b may be the collection of all of the user's favorite outfits. Collections may be made based on the season, for example, collection 710c may be a collection of summer outfits and collection 710d may be a collection of winter outfits. Selecting any of these collections can cause the display each of the outfits in the collection, for example, as shown in FIG. 5. Each collection may be given a name. For example, a collections based on weather may be named “Summer Looks” or “Cool weather.” Collections based on occasion may be named “Workday Collection” or “Date Night Collection.” Collections based on events might be labeled “Europe Trip.” Collections may be created by users based on their favorite outfits within a given theme.

Each collection 710 may include a cover outfit including a template 714 and the matched wardrobe items 712.

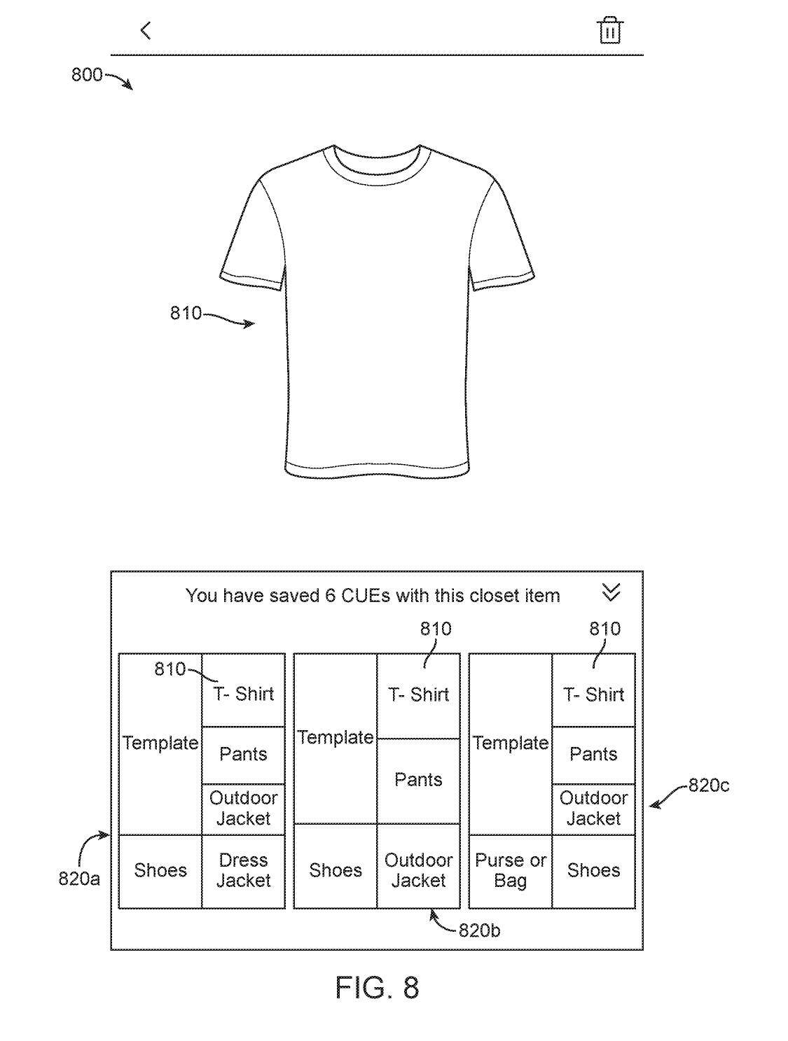

FIG. 8 depicts a view 800 of a clothing item 810 and associated outfits 820. As shown in FIG. 8, each outfit 820a, 820b, 820c includes a selected clothing item 810, a t-shirt. By selecting a particular clothing item from, for example, the wardrobe database 900, a user can see outfits that use that item.

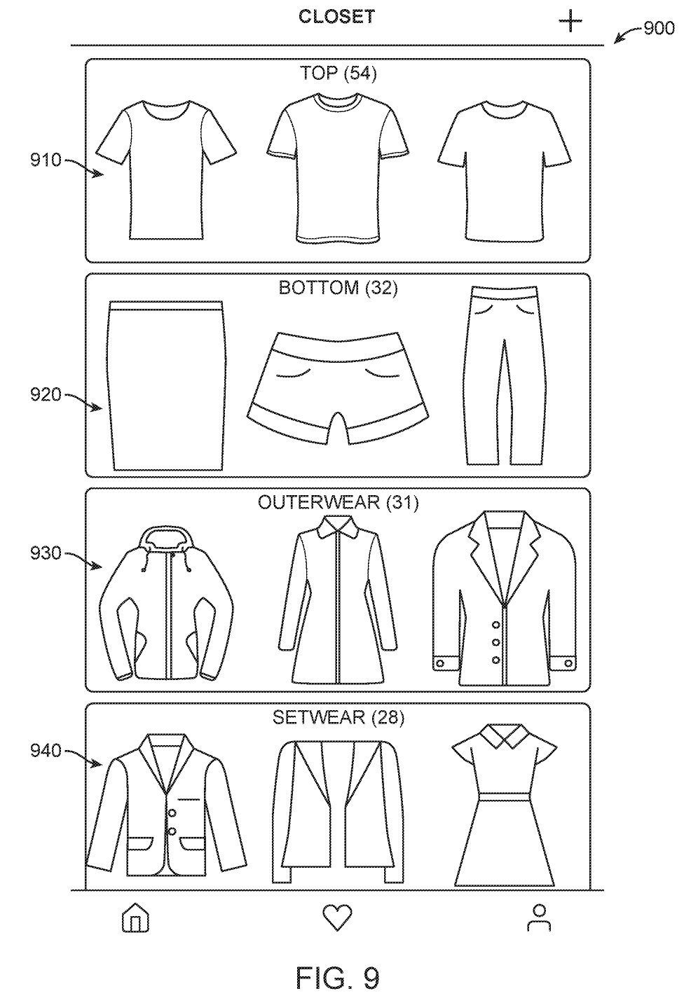

FIG. 9 depicts a closet or wardrobe database 900. The wardrobe database 900 includes each of the user's clothing items. The items may be displayed by category, such as tops 910, bottoms 920, outerwear 930, and setwear 940.

FIG. 10 depicts the rejection of an outfit recommendation. When rejecting an outfit recommendation, a user my swipe the first recommended outfit 1010 to the left as indicated by arrow a, revealing a second recommended outfit 1020. The rejection of the first recommended outfit may be sent as feedback to the recommendation engine.

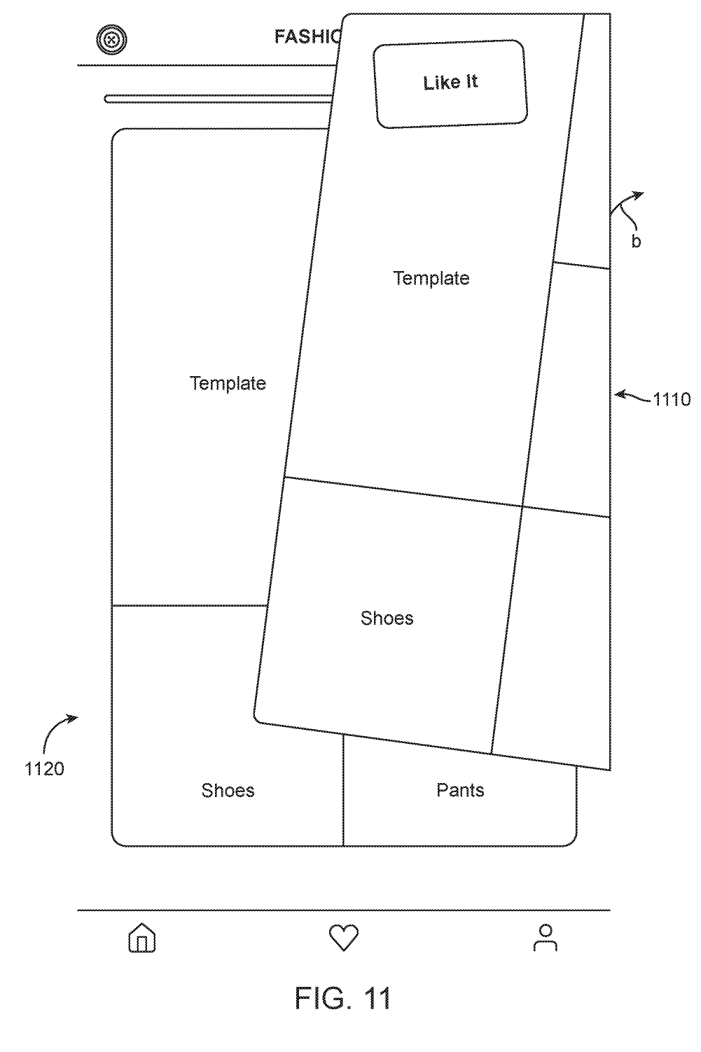

FIG. 11 depicts the liking an outfit recommendation. When liking an outfit recommendation, a user my swipe the first recommended outfit 1110 to the right as indicated by arrow b, revealing a second recommended outfit 1120. The liking of the first recommended outfit may be sent as feedback to the recommendation engine.

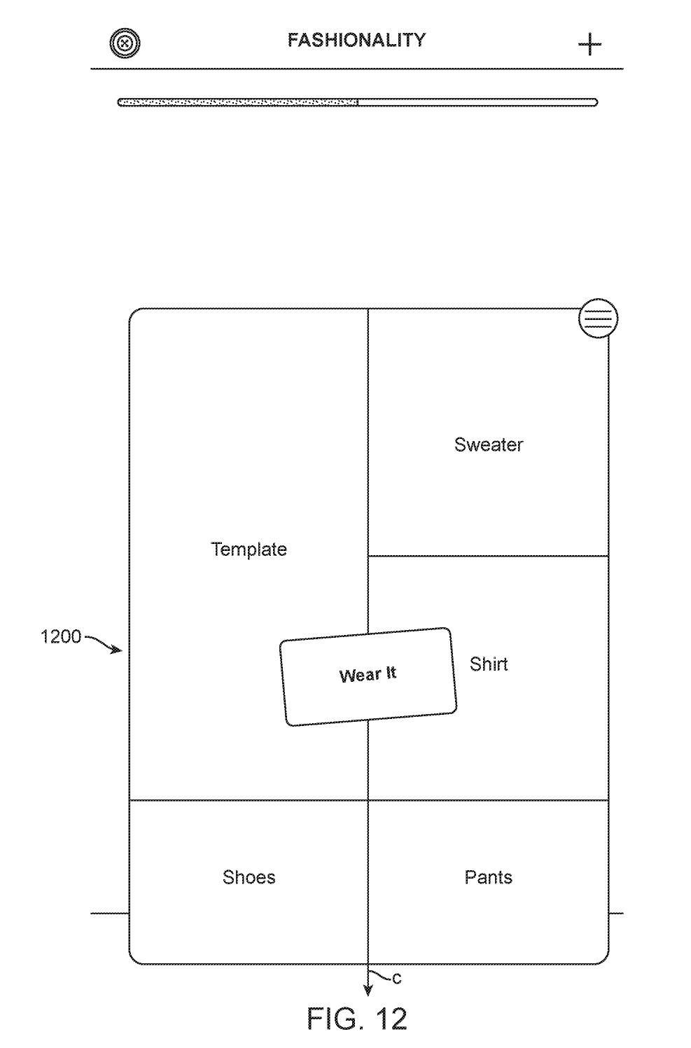

FIG. 12 depicts the selecting an outfit recommendation for wearing. When selecting an outfit recommendation for wearing, a user my swipe the recommended outfit 1200 downward, as indicated by arrow c. The selection of the recommended outfit may be sent as feedback to the recommendation engine.

In this way, the user provides feedback to the recommendation engine. This feedback may be used in the generation of future recommendations.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for building outfits comprising:
a tagging system configured to receive a user's clothing items and tag the clothing items according to their attributes;
an outfit generation engine coupled in electronic communication with the tagging system and configured to receive the tagged clothing items from the tagging system and outfit templates and, using the outfit templates and the tagged clothing items, form a set of recommended outfits;
a user system coupled in electronic communication with the outfit generation engine and configured to receive at least one of the recommended outfits from the outfit generation engine and receive qualitative feedback about the recommended outfit from the user and send the feedback to the outfit generation engine.

2. The system of claim 1 further comprising:
an outfit picker coupling the outfit generation engine in electronic communication with the user system, the outfit picker configured to receive the set of recommended outfits and select an recommended outfit from the set of outfits and send the selected outfit to the user system.

3. The system of claim 2 wherein:
the outfit picker is further configured to receive weather conditions and the user's last-worn-date of their closet items and further use the receive weather conditions and the user's last-worn-date of their closet items when selecting an outfit.

4. The system of claim 1 wherein:
the tagging system comprises an object detection convolutional neural network model to detect and tag one each clothing item.

5. The system of claim 4 wherein:
the tagging system comprises a plurality of classifiers, each classifier trained to classify a different attribute of each clothing item.

6. The system of claim 1 wherein:
the generation system includes a first probabilistic ranking model to select outfit templates based on a user's feedback to create a first subset of outfit templates.

7. The system of claim 6 wherein:
the generation system includes a second probabilistic ranking model to match the first subset of outfit templates with the clothing items to create a set of recommended outfits.

8. The system of claim 1 wherein:
the feedback comprises the outfits the user has liked, disliked, and worn.

9. The system of claim 1 further comprising:
a closet item storage system coupling the tagging system and the generation system in electronic communication, the closet item storage system storing tagged closet items and providing them to the generation system.

10. The system of claim 1 further comprising:
a template storage system coupling the tagging system and the generation system in electronic communication, the template storage system storing tagged templates and providing them to the generation system.

11. A method for building outfits comprising:
tagging a user's clothing items according to their attributes;
forming a set of recommended outfits based on the tagged clothing items and a set of outfit templates; and
receiving feedback from the user about at least one recommended outfit of the set of recommended outfits; and
forming a second set of recommended outfits based on the feedback, tagged clothing items, and the set of outfit templates.

12. The method of claim 11 further comprising:
selecting a recommended outfit from the set of outfits and send the selected outfit to the user system.

13. The method of claim 12 wherein:
selecting the recommended outfit is based on weather conditions and the user's last-worn-date of their closet items.

14. The method of claim 11 wherein:
tagging comprises an object detection convolutional neural network model to detect and tag one each clothing item.

15. The method of claim 14 wherein:
tagging comprises using a plurality of classifiers, each classifier trained to classify a different attribute of each clothing item.

16. The method of claim 11 wherein:
forming the set of recommended outfits includes a first probabilistic ranking model selecting outfit templates based on a user's feedback to create a first subset of outfit templates.

17. The method of claim 16 wherein:
forming the set of recommended outfits includes a second probabilistic ranking model matching the first subset of outfit templates with the clothing items to create the set of recommended outfits.

18. The method of claim 11 wherein:
the feedback comprises the outfits the user has liked, disliked, and worn.

19. The method of claim 11 further comprising:
providing templates to a tagging system; and
tagging clothing items in the template according to each clothing item's attributes.

20. The system of claim 11 further comprising:
providing the user's clothing items to a tagging system; and
tagging the user's clothing items according to each user's clothing item's attributes.
